(19) United States
(12) Patent Application Publication
(10) Pub. No.: US 2020/0207332 A1
(43) Pub. Date: Jul. 2, 2020

(54) Method and Apparatus for Controlling a Vehicle

(71) Applicant: ARRIVAL LIMITED, Banbury Oxfordshire (GB)

(72) Inventors: Christoforos Chatzikomis, Guildford Surrey (GB); Patrick Gruber, Guildford Surrey (GB); Aldo Sorniotti, Guildford Surrey (GB); Mazuir SHAH, Banbury Oxfordshire (GB); Matthew Bastin, Banbury Oxfordshire (GB)

(21) Appl. No.: 16/612,673

(22) PCT Filed: Apr. 26, 2018
(86) PCT No.: PCT/GB2018/051099

§ 371 Date: Nov. 11, 2019

(30) Foreign Application Priority Data
May 11, 2017 (GB) 1707537.5

(51) Int. Cl. B60W 30/045; B60L 15/20; B60W 30/18; B60W 40/114

(52) U.S. Cl. CPC B60W 30/045; B60L 15/2036; B60K 2023/0858; B60W 40/114; B60W 30/18172

(57) ABSTRACT

A method of controlling a vehicle is disclosed, the method comprising steps of: determining a saturated reference yaw moment based on an initial reference yaw moment and a total wheel torque demand, taking into account operational limits of the vehicle; determining initial torque allocations for each one of a plurality of wheels of the electric vehicle based on the saturated reference yaw moment; and for each one of the plurality of wheels, checking whether the initial torque allocation for said wheel exceeds a corresponding wheel torque limit for said wheel. In response to a determination that the initial torque allocation for a first wheel exceeds the corresponding wheel torque limit, and that the initial torque allocation for a second wheel on the same side of the vehicle is less than the corresponding wheel torque limit, the initial torque allocations are revised by increasing the torque allocation to the second wheel. The electric vehicle can then be controlled to apply the revised torque allocations to the plurality of wheels. Apparatus for controlling a vehicle is also disclosed.

### TECHNICAL FIELD

The present invention relates to controlling a vehicle, for example an electric vehicle. In particular, the present invention relates to methods and apparatus for determining torque allocations for a plurality of wheels of the vehicle.

### BACKGROUND

Electric vehicles are known in which each wheel of the vehicle is provided with its own dedicated electric motor. This arrangement allows the wheels of the vehicle to be driven independently from one another, and allows a different torque to be applied to each wheel. The process of determining how to allocate the available torque amongst the wheels is referred to as torque allocation.

Various torque allocation methods are known. For example, torque can be allocated to different wheels so as to optimise the tyre forces. However, this process can be computationally expensive to implement, and the optimisation process must be done in real-time.

The invention is made in this context.

### SUMMARY OF THE INVENTION

According to a first aspect of the present invention, there is provided a method of controlling a vehicle, the method comprising: determining a saturated reference yaw moment based on an initial reference yaw moment and a total wheel torque demand, taking into account operational limits of the vehicle; determining initial torque allocations for each one of a plurality of wheels of the electric vehicle based on the saturated reference yaw moment; for each one of the plurality of wheels, checking whether the initial torque allocation for said wheel exceeds a corresponding wheel torque limit for said wheel; in response to a determination that the initial torque allocation for a first wheel among the plurality of wheels exceeds the corresponding wheel torque limit for the first wheel, and that the initial torque allocation for a second wheel among the plurality of wheels on the same side of the vehicle as the first wheel is less than the corresponding wheel torque limit for the second wheel, revising the initial torque allocations by increasing the torque allocation to the second wheel, and controlling the electric vehicle to apply the revised torque allocations to the plurality of wheels.

In some embodiments according to the first aspect, the initial torque allocations are determined based on a vertical load on each of the plurality of wheels. For example, in one embodiment according to the first aspect, the initial torque allocations on one side of the electric vehicle are determined by allocating torque to the plurality of wheels on that side of the electric vehicle in proportion to the respective vertical loads on said wheels.

In some embodiments according to the first aspect, determining the saturated reference yaw moment comprises: determining whether the reference yaw moment exceeds a maximum yaw moment or a minimum yaw moment defined by the operational limits, for the total wheel torque demand; and in response to a determination that the reference yaw moment exceeds the maximum yaw moment or the minimum yaw moment, capping the saturated reference yaw moment at the maximum yaw moment or the minimum yaw moment respectively.

In some embodiments according to the first aspect, the operational limits of the electric vehicle are determined based on a maximum and minimum torque that can be applied to each wheel of the electric vehicle, the operational limits comprising: a maximum yaw moment that can be obtained by applying the maximum torques to a first plurality of wheels on one side of the electric vehicle and applying the minimum torques to a second plurality of wheels on an opposite side of the electric vehicle; a minimum yaw moment that can be obtained by applying the minimum torques to the first plurality of wheels and applying the maximum torques to the second plurality of wheels; a maximum total wheel torque that can be obtained by applying the maximum torque to each wheel of the electric vehicle; and a minimum total wheel torque that can be obtained by applying the minimum torque to each wheel of the electric vehicle.

According to a second aspect of the present invention, there is provided a computer-readable storage medium arranged to store computer program instructions which, when executed, perform a method according to the first aspect.

According to a third aspect of the present invention, there is provided apparatus for controlling a vehicle, the apparatus comprising: a vehicle control unit configured to control the electric vehicle; a torque allocation unit configured to determine a saturated reference yaw moment based on an initial reference yaw moment and a total wheel torque demand, taking into account operational limits of the vehicle, and determine initial torque allocations for each one of a plurality of wheels of the electric vehicle based on the saturated reference yaw moment; a wheel torque limit checking unit configured to check, for each one of the plurality of wheels, whether the initial torque allocation for said wheel exceeds a corresponding wheel torque limit for said wheel; and a torque reallocation unit, wherein in response to a determination that the initial torque allocation for a first wheel among the plurality of wheels exceeds the corresponding wheel torque limit for the first wheel, and that the initial torque allocation for a second wheel among the plurality of wheels on the same side of the vehicle as the first wheel is less than the corresponding wheel torque limit for the second wheel, the torque reallocation unit is configured to revise the initial torque allocations by increasing the torque allocation to the second wheel, and to control the vehicle control unit to apply the revised torque allocations to the plurality of wheels.

In some embodiments according to the third aspect, the torque allocation unit is configured to determine the initial torque allocations based on a vertical load on each of the plurality of wheels. For example, in one embodiment according to the third aspect, the torque allocation unit is configured to determine the initial torque allocations on one side of the electric vehicle by allocating torque to the plurality of wheels on that side of the electric vehicle in proportion to the respective vertical loads on said wheels.

In some embodiments according to the third aspect, the torque allocation unit is configured to determine the saturated reference yaw moment by determining whether the reference yaw moment exceeds a maximum yaw moment or a minimum yaw moment defined by the operational limits, for the total wheel torque demand, and in response to a determination that the reference yaw moment exceeds the maximum yaw moment or the minimum yaw moment, capping the saturated reference yaw moment at the maximum yaw moment or the minimum yaw moment respectively.

In some embodiments according to the third aspect, the torque allocation unit is configured to determine the operational limits of the electric vehicle based on a maximum and minimum torque that can be applied to each wheel of the electric vehicle, the operational limits comprising: a maximum yaw moment that can be obtained by applying the maximum torques to a first plurality of wheels on one side of the electric vehicle and applying the minimum torques to a second plurality of wheels on an opposite side of the electric vehicle; a minimum yaw moment that can be obtained by applying the minimum torques to the first plurality of wheels and applying the maximum torques to the second plurality of wheels; a maximum total wheel torque that can be obtained by applying the maximum torque to each wheel of the electric vehicle; and a minimum total wheel torque that can be obtained by applying the minimum torque to each wheel of the electric vehicle.

According to a fourth aspect of the present invention, there is provided apparatus for controlling a vehicle, the apparatus comprising: one or more processors; and computer-readable memory arranged to store computer program instructions which, when executed by the one or more processors, cause the one or more processors to determine a saturated reference yaw moment based on an initial reference yaw moment and a total wheel torque demand, taking into account operational limits of the vehicle, determine initial torque allocations for each one of a plurality of wheels of the electric vehicle based on the saturated reference yaw moment, for each one of the plurality of wheels, check whether the initial torque allocation for said wheel exceeds a corresponding wheel torque limit for said wheel, in response to a determination that the initial torque allocation for a first wheel among the plurality of wheels exceeds the corresponding wheel torque limit for the first wheel, and that the initial torque allocation for a second wheel among the plurality of wheels on the same side of the vehicle as the first wheel is less than the corresponding wheel torque limit for the second wheel, revise the initial torque allocations by increasing the torque allocation to the second wheel, and control the electric vehicle to apply the revised torque allocations to the plurality of wheels.

In some embodiments according to the fourth aspect, the computer program instructions are configured to cause the initial torque allocations to be determined based on a vertical load on each of the plurality of wheels. For example, in one embodiment according to the fourth aspect, the computer program instructions are configured to cause the initial torque allocations on one side of the electric vehicle to be determined by allocating torque to the plurality of wheels on that side of the electric vehicle in proportion to the respective vertical loads on said wheels.

In some embodiments according to the fourth aspect, the computer program instructions are configured to cause the saturated reference yaw moment to be determined by: determining whether the reference yaw moment exceeds a maximum yaw moment or a minimum yaw moment defined by the operational limits, for the total wheel torque demand; and in response to a determination that the reference yaw moment exceeds the maximum yaw moment or the minimum yaw moment, capping the saturated reference yaw moment at the maximum yaw moment or the minimum yaw moment respectively.

In some embodiments according to the fourth aspect, the computer program instructions are configured to cause the operational limits of the electric vehicle to be determined based on a maximum and minimum torque that can be applied to each wheel of the electric vehicle, the operational limits comprising: a maximum yaw moment that can be obtained by applying the maximum torques to a first plurality of wheels on one side of the electric vehicle and applying the minimum torques to a second plurality of wheels on an opposite side of the electric vehicle; a minimum yaw moment that can be obtained by applying the minimum torques to the first plurality of wheels and applying the maximum torques to the second plurality of wheels; a maximum total wheel torque that can be obtained by applying the maximum torque to each wheel of the electric vehicle; and a minimum total wheel torque that can be obtained by applying the minimum torque to each wheel of the electric vehicle.

According to a fifth aspect of the present invention, there is provided a vehicle comprising the apparatus according to the third aspect or the fourth aspect. In some embodiments according to the fifth aspect, the vehicle is an electric vehicle.

### BRIEF DESCRIPTION OF THE DRAWINGS

Embodiments of the present invention will now be described, by way of example only, with reference to the accompanying drawings, in which:

FIG. 1 illustrates an electric vehicle according to an embodiment of the present invention;

FIG. 2 illustrates a yaw moment experienced by the electric vehicle when different levels of torque are applied on opposite sides of the vehicle, according to an embodiment of the present invention;

FIG. 3 illustrates notation used throughout this document to refer to certain vehicle dimensions and components of forces acting on the vehicle;

FIG. 4 illustrates the operational boundaries of the vehicle, as defined by the maximum and minimum yaw moments and the maximum and minimum wheel torques, according to an embodiment of the present invention;

FIG. 5 illustrates a change in the operational boundaries due to a decrease in the maximum wheel torque for the right-hand front tyre or the right-hand rear tyre;

FIG. 6 illustrates a change in the operational boundaries due to a decrease in the maximum wheel torque for the left-hand front tyre or the left-hand rear tyre;

FIG. 7 is a flowchart showing a method of controlling an electric vehicle, according to an embodiment of the present invention;

FIG. 8 is a flowchart showing a method for determining whether to revise the initial torque allocations, according to an embodiment of the present invention;

FIG. 9 is a flowchart showing a method of revising the initial torque allocations if the torque allocation for any of the wheels would exceed the operational limits, according to an embodiment of the present invention; and

FIG. 10 schematically illustrates the structure of a control unit for controlling an electric vehicle, according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the scope of the present invention. Accordingly, the drawings and description are to be regarded as illustrative in nature and not restrictive. Like reference numerals designate like elements throughout the specification.

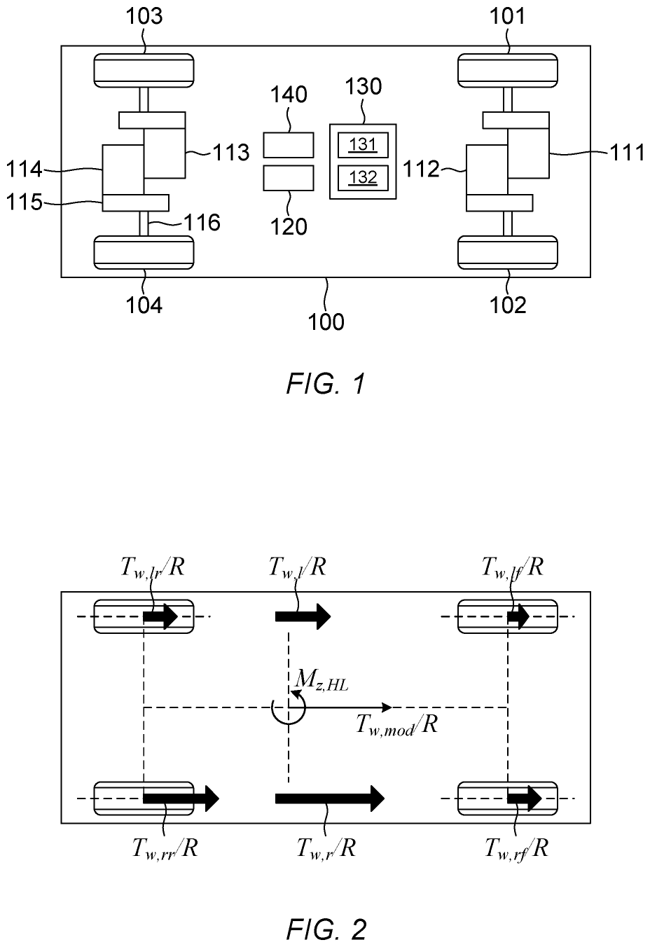

Referring now to FIG. 1, an electric vehicle is illustrated according to an embodiment of the present invention. In the present embodiment the vehicle 100 comprises four wheels 101, 102, 103, 104, and four electric motors 111, 112, 113, 114 each arranged to independently drive a respective one of the wheels 101, 102, 103, 104 via a gearbox 115 and axle 116. The wheels are arranged as a pair of front wheels 101, 102 and a pair of rear wheels 103, 104. However, other numbers of wheels and other arrangements are possible in other embodiments. In some embodiments additional axles may be provided and/or the vehicle may comprise an odd number of wheels, for example a pair of rear wheels and a single front wheel.

A wheel that is capable of being driven by an electric motor can be referred to as a ‘driven wheel’. In addition to a plurality of driven wheels, in some embodiments of the present invention a vehicle may further comprise one or more non-driven wheels which are not connected to an electric motor, but which instead rotate freely due to contact with the road surface while the vehicle is in motion. For example, in another embodiment of the present invention, the front wheels may be non-driven wheels and only the rear wheels may be driven by electric motors, or vice versa.

The plurality of motors 111, 112, 113, 114 can be controlled in order to impart a yaw moment on the electric vehicle 100. Here, ‘yaw’ is used in its conventional meaning, to refer to rotation of the vehicle about the vertical axis. For example, the plurality of motors 111, 112, 113, 114 can be controlled so as to apply a higher torque to the wheels on one side of the vehicle 100 than a torque that is applied to the wheels on the other side of the vehicle 100, with the result that a greater accelerating force is experienced by the vehicle 100 on the side on which the higher torque is applied. As a result, the vehicle 100 is subject to a moment about the vertical axis. This moment can be referred to as the yaw moment, and the vertical axis can be referred to as the yaw axis.

FIG. 2 illustrates a yaw moment M_{z,HL} experienced by the electric vehicle 100 when different levels of torque are applied on opposite sides of the vehicle 100. In FIG. 2, T_{w,rr} denotes the torque applied to the right rear wheel 104, T_{w,lr} denotes the torque applied to the left rear wheel 103, T_{w,rf} denotes the torque applied to the right front wheel 102, T_{w,lr} denotes the torque applied to the left front wheel 101, T_{w,r} denotes the total torque applied to the wheels 102, 104 on the right-hand side of the vehicle 100, T_{w,l} denotes the total torque applied to the wheels 101, 103 on the left-hand side of the vehicle 100, and T_{w,mod} denotes the total torque applied to all four wheels 101, 102, 103, 104 of the vehicle 100.

Continuing with reference to FIG. 1, the vehicle 100 further comprises a yaw rate sensor 120 arranged to measure the yaw rate of the vehicle 100, and a control unit 130 configured to determine a reference yaw moment M_{z} for the vehicle 100 in accordance with a reference yaw rate r_{ref}, based on the error between the reference yaw rate r_{ref} and a yaw rate measurement r obtained by the yaw rate sensor 120. The control unit 130 is further configured to determine a torque allocation based on the reference yaw moment M_{z} and the total wheel torque demand T_{w,mod}, the torque allocation defining a torque to be applied to each of the plurality of wheels 101, 102, 103, 104, and control the plurality of electric motors 111, 112, 113, 114 to apply the determined torque allocation to the plurality of wheels 101, 102, 103, 104.

The yaw rate is the angular velocity of the rotation about the yaw axis, and is commonly expressed in terms of degrees per second or radians per second. The yaw rate sensor 120 can be any suitable type of yaw rate sensor, such as a piezoelectric sensor or micromechanical sensor. Examples of suitable yaw rate sensors are known in the art, and a detailed explanation of the operation of the yaw rate sensor 120 will not be provided here, so as to avoid obscuring the present inventive concept.

Depending on the embodiment, the control unit 130 may be implemented in hardware, for example using an application-specific integrated circuit (ASIC) or field-programmable gate array (FPGA), or may be implemented in software. In the present embodiment a software implementation is used, and the control unit 130 comprises a processing unit 131 and computer-readable memory 132 arranged to store computer programme instructions that can be executed by the processing unit 131 in order to determine the reference yaw rate. The processing unit 131 can comprise one or more processors.

The control unit 130 is configured to determine the reference yaw rate based on the steering angle δ and vehicle speed V and adjusted in accordance with the obtained value of the rear wheel sideslip angle βᵣ, which describes the amount of sideslip currently being experienced by the vehicle in line with the rear axle. Depending on the embodiment, the sideslip angle may be measured at a point in-line with the rear axle 116, or may be derived from a measurement of the sideslip angle at a certain distance from the rear axle 116, for example a measurement taken at the centre of gravity of the vehicle 100. In some embodiments, instead of directly measuring the slip angle, the current value of the slip angle can be obtained by deriving an estimated slip angle based on measurements of one or more other physical quantities. For example, an estimated slip angle may be derived based on the current steering angle, yaw rate, lateral acceleration and forward acceleration.

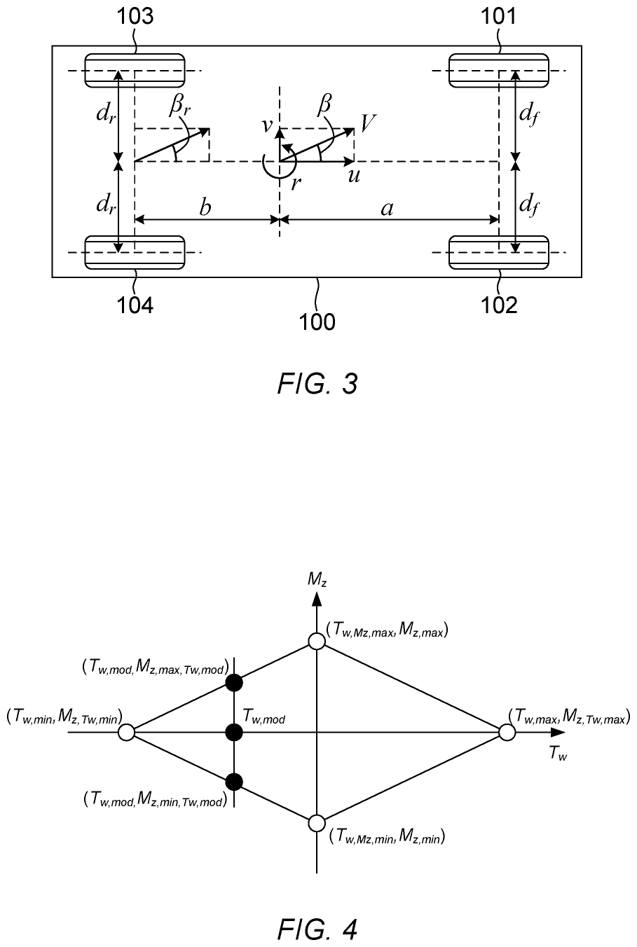

FIG. 3 illustrates notation used to refer to certain vehicle dimensions and components of forces acting on the vehicle 100. The following definitions are used throughout this document:
β=sideslip angle at centre of gravity of the vehicle
βᵣ=rear wheel sideslip angle
u=velocity component in forward direction
v=lateral velocity component
V=actual velocity of vehicle
r=vehicle yaw rate
a=distance between front axle and centre of gravity of the vehicle
b=distance between rear axle and centre of gravity of the vehicle
d_{f}=half-track width (front)
dᵣ=half-track width (rear)
d=average half-track width=(d_{f}+dᵣ)/2
R=wheel radius

In the present embodiment, the following sign convention is adopted: a rotation in the anticlockwise direction (i.e. turning the vehicle to the left) is defined as a positive yaw moment or yaw rate; and a rotation in the clockwise rotation (i.e. turning the vehicle to the right) is defined as a negative yaw moment or yaw rate. It will be appreciated that the equations disclosed herein could be modified as necessary if the opposite sign convention were to be adopted. It will also be appreciated that the equations disclosed herein are formulated for a four-wheeled vehicle in which each wheel can be driven independently, and the equations may be modified as necessary if the vehicle comprises a different number of driven wheels.

When allocating the available torque to the wheels of the vehicle 100, the control unit 130 may take into account certain operational limits of the vehicle 100. In the present embodiment, the operational limits are determined based on a maximum and minimum torque that can be applied to each wheel of the electric vehicle 100, referred to as the maximum and minimum wheel torque limits. The wheel torque limits for any given wheel depend upon factors such as the maximum and minimum torque that can be exerted by the electric motor, and the wheel operating conditions. The wheel operating conditions can be defined in terms of various parameters, including but not limited to the friction coefficient between the wheel and the road surface, slip ratio, and vertical load. The operational limits are defined in terms of boundaries determined by the following parameters:
The maximum yaw moment, M_{z,max}, that can be obtained by applying the maximum torques to the wheels on one side of the electric vehicle and applying the minimum torques to the wheels on the opposite side of the electric vehicle;
The minimum yaw moment, M_{z,min}, that can be obtained in the opposite direction to the maximum yaw moment, by applying the minimum torques to the wheels on one side and applying the maximum torques to the wheels on the other side;
The maximum total wheel torque, T_{w,max}, that can be obtained by applying the maximum torque to each wheel of the electric vehicle; and
The minimum total wheel torque, T_{w,min}, that can be obtained by applying the minimum torque to each wheel of the electric vehicle.

The maximum yaw moment M_{z,max}, which is the largest yaw moment in the positive direction (i.e. turning the vehicle to the left), will occur when the minimum torque is applied to the wheels on the left-hand side of the vehicle 100 and the maximum torque is applied to the wheels on the right-hand side of the vehicle 100, as follows:

$${M}_{z , max} = ( {T}_{w , rf , max} {d}_{f} + {T}_{w , rr , max} {d}_{r} - {T}_{w , lf , min} {d}_{f} - {T}_{w , lr , min} {d}_{r} ) \frac{1}{R}$$

The total wheel torque when the maximum yaw moment is being applied, T_{w,Mz,max}, is given by:

T_{w,M}_{_{z,max}}=T_{w,rf,max}+T_{w,rr,max}+T_{w,lf,min}+T_{w,lr,min}

The minimum yaw moment M_{z,min}, which is the largest yaw moment in the negative direction (i.e. turning the vehicle to the right), will occur when the minimum torque is applied to the wheels on the right-hand side of the vehicle 100 and the maximum torque is applied to the wheels on the left-hand side of the vehicle 100, as follows:

$${M}_{z , min} = ( {T}_{w , rf , min} {d}_{f} + {T}_{w , rr , min} {d}_{r} - {T}_{w , lf , max} {d}_{f} - {τ}_{w , lr , max} {d}_{r} ) \frac{1}{R}$$

The total wheel torque when the minimum yaw moment is being applied, T_{w,Mz,min}, is given by:

T_{w,M}_{_{z,min}}=T_{w,rf,min}+T_{w,rr,min}+T_{w,lf,max}+T_{w,lr,max}

The maximum wheel torque T_{w,max} is the maximum total torque that can be applied to all wheels of the vehicle 100, as follows:

T_{w,max}=T_{w,rf,max}+T_{w,rr,max}+T_{w,lf,max}+T_{w,lr,max}

The resulting yaw moment on the vehicle 100 when the maximum torque is being applied to each wheel, M_{z,Tw,max}, is given by:

$${M}_{z , {T}_{w , max}} = ( {T}_{w , rf , max} {d}_{f} + {T}_{w , rr , max} {d}_{r} - {T}_{w , lf , max} {d}_{f} - {T}_{w , lr , max} {d}_{r} ) \frac{1}{R}$$

Similarly, the minimum wheel torque T_{w,min} is the minimum total torque that can be applied to all wheels of the vehicle 100, as follows:

T_{w,min}=T_{w,rf,min}+T_{w,rr,min}+T_{w,lf,min}+T_{w,lr,min}

The resulting yaw moment on the vehicle 100 when the minimum torque is being applied to each wheel, M_{z,Tw,min}, is given by:

$${M}_{z , {T}_{w , min}} = ( {T}_{w , rf , min} {d}_{f} + {T}_{w . rr , min} {d}_{r} - {T}_{w , lf , min} {d}_{f} - {T}_{w , lr , min} {d}_{r} ) \frac{1}{R}$$

The operational boundaries of the vehicle in the present embodiment, as defined by the maximum and minimum yaw moments M_{z,max}, M_{z,min} and the maximum and minimum wheel torques T_{w,max}, T_{w,min}, are plotted in FIG. 4. The graph in FIG. 4 illustrates the operational boundaries under nominal conditions. The boundaries may move as the vehicle conditions change, for example during cornering the shape defined by the operational boundaries may change as a result of changes in the vertical loads, motor limits, and/or friction coefficients at the wheels. In the present embodiment, all four electric motors 111, 112, 113, 114 are capable of applying the same maximum torque, and of applying equal levels of traction and braking torque. That is, the maximum torque that can be applied to each wheel is equal in magnitude and opposite in sign to the minimum torque that can be applied to that wheel, i.e. T_{w,max}=−T_{w,min}. Also, in the present embodiment the front half-track width d_{f} is equal to the rear half-track width dᵣ. Accordingly, the total wheel torques T_{w,Mz,max}, T_{w,Mz,min} at the maximum and minimum yaw moments M_{z,max}, M_{z,min} are both equal to zero, since the torque on one side of the vehicle is equal in magnitude and opposite in sign to the total torque on the other side of the vehicle. Therefore the points (T_{w,Mz,max}, M_{z,max}) and (T_{w,Mz,min}, M_{z,min}) both lie on the y-axis, i.e. the line T_{w}=0.

Similarly, in the present embodiment the total yaw moment when either the maximum wheel torque T_{w,max} or the minimum wheel torque T_{w,min} is applied is equal to zero, since equal torques are applied on both sides of the vehicle 100. Hence in FIG. 4, the points (T_{w,max}, M_{z,Tw,max}) and (T_{w,min}, M_{z,Tw,min}) both lie on the x-axis, i.e. the line M_{z}=0.

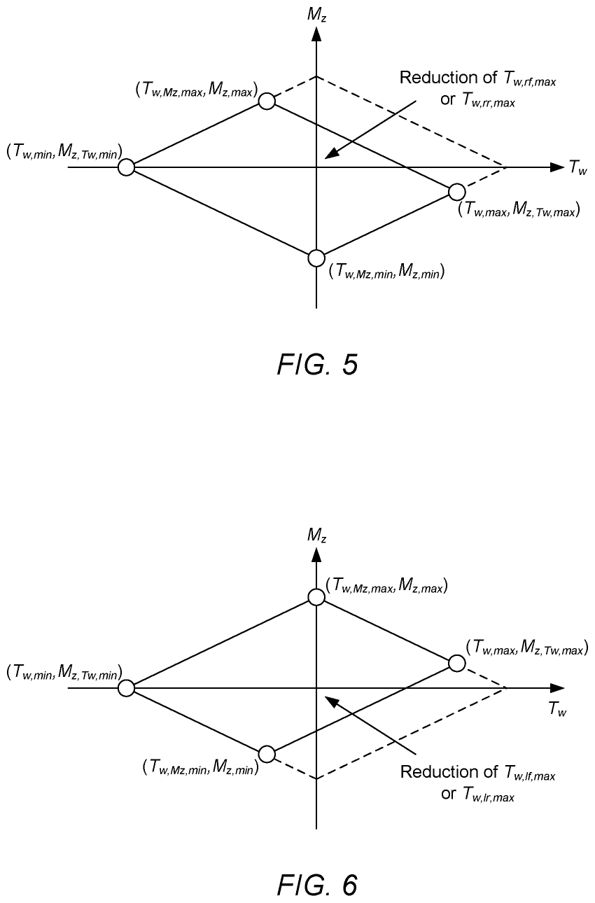

The significance of the operational limits can be further explained with reference to FIGS. 5 and 6. FIG. 5 illustrates how the operational limits change when the maximum torque that can be applied to either of the right-hand wheels 102, 104 decreases, for example due to a fault in one of the right-hand motors 112, 114. FIG. 6 illustrates how the operational limits change when the maximum torque that can be applied to either of the left-hand wheels 101, 103 decreases, for example due to a fault in one of the left-hand motors 111, 113. A decrease in the maximum torque for one wheel results in an imbalance when the maximum wheel torque T_{w,max} is applied, resulting in a net positive or negative moment M_{z,Tw,max}. A decrease in the maximum torque for one wheel also results in a reduction in the maximum yaw moment that can be applied. For example, if the decrease occurs on one of the right-hand wheels 102, 104, the maximum yaw moment that can be applied in the positive direction M_{z,max} decreases. Similarly, if the decrease occurs on one of the left-hand wheels 101, 103, the maximum yaw moment that can be applied in the negative direction M_{z,min} decreases.

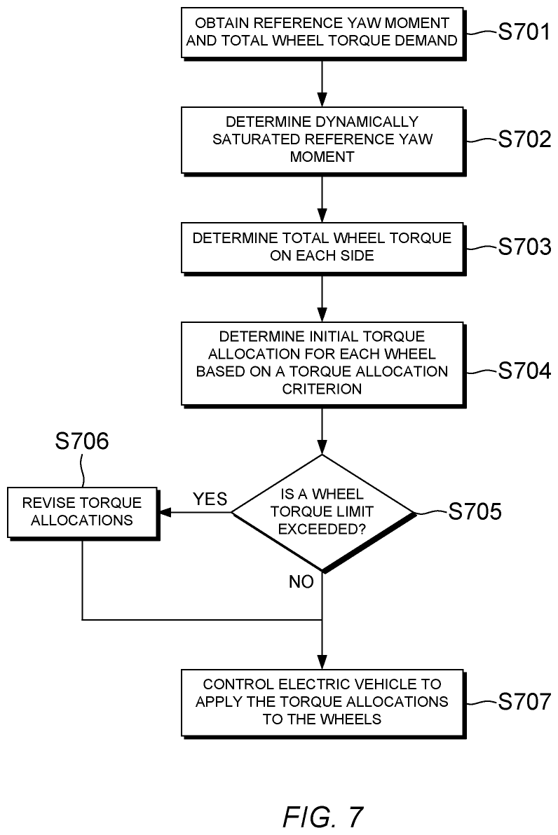

Referring now to FIG. 7, a flowchart showing a method of controlling an electric vehicle is illustrated, according to an embodiment of the present invention. The flowchart illustrates steps performed by the control unit 130.

In step S701 the control unit 130 sets a reference yaw rate r_{ref} and determines a reference yaw moment M_{z,HL} in order to track the reference yaw rate r_{ref}. The control unit 130 also receives control inputs from the driver in the form of the total wheel torque demand T_{w,mod} and steering angle δ. The reference yaw moment M_{z,HL} and the total wheel torque demand T_{w,mod} can be set in accordance with current operating conditions of the electric vehicle. For example, in some embodiments the control unit 130 may automatically adjust the total wheel torque demand T_{w,mod} when a large yaw rate error is detected.

In the present embodiment the control unit 130 is configured to set the reference yaw rate r_{ref} based on the steering angle δ and vehicle speed V, and adjusted in accordance with the obtained value of the rear wheel sideslip angle βᵣ. The reference yaw rate r_{ref} is a yaw rate that is deemed to be appropriate for the vehicle handling characteristics and the current friction conditions at the wheels. For example, the control unit 130 may set a higher reference yaw rate for a lower rear wheel sideslip angle, and may set a lower reference yaw rate for a higher rear wheel sideslip angle.

In other embodiments a different method of setting the reference yaw rate r_{ref} may be used in step S701, without considering the rear wheel sideslip angle βᵣ. For example, in another embodiment the reference yaw rate r_{ref} may be determined based on estimated coefficients of friction between the tyres and the road surface, or may be determined using any other suitable method. Methods of setting the reference yaw rate r_{ref} and reference yaw moment M_{z,HL} are known in the art, and a detailed explanation of alternative approaches will not be provided here, to avoid obscuring the present inventive concept. For example, in another embodiment the reference yaw rate r_{ref} may be determined using a method similar to the one disclosed in “Bosch ESP Systems: 5 Years of Experience”, van Zanten, A., SAE Technical Paper 2000-01-1633, 2000, doi:10.4271/2000-01-1633, in which r_{ref} is determined based on the vehicle speed and steering angle, taking into account vehicle parameters including the wheelbase and a characteristic speed.

Next, in step S702 the control unit 130 determines a dynamically saturated reference yaw moment, M_{z,HL,sat}, taking into account the operational limits. The dynamically saturated reference yaw moment M_{z,HL,sat} is the maximum yaw moment that can be achieved in the direction of the reference yaw moment, whilst still satisfying the total wheel torque demand T_{w,mod}. In the present embodiment, the dynamically saturated reference yaw moment M_{z,HL,sat} is defined as follows:

$${M}_{z , HL , sat} = \{ \begin{matrix}{M}_{z , max , {T}_{w , mod}} , & if {M}_{z , HL} \geq {M}_{z , max , {T}_{w , mod}} \\ {M}_{z , HL} , & if {M}_{z , min , {T}_{w , mod}} < {M}_{z , HL} < {M}_{z , max , {T}_{w , mod}} \\ {M}_{z , min , {T}_{w , mod}} , & if {M}_{z , HL} \leq {M}_{z , min , {T}_{w , mod}}\end{matrix}$$

In other embodiments the saturated reference yaw moment may be capped at a certain percentage of the maximum or minimum yaw moments in order to allow for a safety factor. For example, in some embodiments the saturated reference yaw moment may be capped at 0.9 M_{z,max,Tw,mod} in the positive direction and at 0.9 M_{z,min,Tw,mod} in the negative direction.

Once the saturated reference yaw moment M_{z,HL,sat} has been obtained, then in step S703 the control unit 130 determines a total wheel torque that could be applied to each side of the vehicle 100 in order to generate the saturated reference yaw moment M_{z,HL,sat} and satisfy the total wheel torque demand T_{w,mod}, as follows:

$${T}_{w , l} = 0.5 ( {T}_{w , mod} - \frac{{M}_{z , HL , sat}}{d} R ) \\ {T}_{w , r} = 0 .5 ( {T}_{w , mod} + \frac{{M}_{z , HL , sat}}{d} R )$$

where T_{w,l} is the total wheel torque on the left-hand side of the vehicle 100, and T_{w,r} is the total wheel torque on the right-hand side of the vehicle 100.

Next, in step S704 the control unit 130 determines initial torque allocations for each one of a plurality of wheels on each side of the vehicle 100 in accordance with a torque allocation criterion. In the present embodiment control unit 130 uses a vertical load on each of the plurality of wheels as the torque allocation criterion. In other embodiments, a different criterion may be used to determine how to allocate the torque amongst the wheels on one side of the vehicle 100. Examples of alternative criterion that may be used to allocate torque in step S704 in other embodiments include, but are not limited to minimization of: tyre work load; tyre slip losses; and drivetrain power input.

For example, the control unit 130 can be configured to estimate the vertical load on each wheel based on information about the vehicle weight, suspension geometry and/or driving conditions. When the vehicle 100 is cornering, the vertical load on the wheels on the outside of the corner will increase, and the vertical load on the wheels on the inside of the corner will decrease. Also, the vertical load will change during acceleration or braking. Additionally, the vertical loads will change due to aerodynamic properties of the vehicle 100, for example aerodynamic nose lift may reduce the vertical load on the front wheels. The control unit 130 can be programmed in advance with the necessary information to estimate the vertical load on each wheel.

In the present embodiment, once the control unit 130 has determined the vertical load on each wheel, for example by estimating the vertical load as described above or by receiving a measurement from a sensor, the control unit 130 determines initial torque allocations for each wheel T_{w,lf}, T_{w,lr}, T_{w,rf}, T_{w,rr} as follows:

$${T}_{w , lf} = {T}_{w , l} \frac{{F}_{z , lf}}{{F}_{z , lf} + {F}_{z , lr}}$$

$${T}_{w , lf} = {T}_{w , l} \frac{{F}_{z , lr}}{{F}_{z , lf} + {F}_{z , lr}}$$

$${T}_{w , rf} = {T}_{w , r} \frac{{F}_{a , rf}}{{F}_{z , rf} + {F}_{z , rr}}$$

$${T}_{w , rr} = {T}_{w , r} \frac{{F}_{z , rr}}{{F}_{z , rf} + {F}_{z , rr}}$$

Here, T_{w,lf} is the initial torque allocation for the front left wheel, T_{w,lr} is the initial torque allocation for the rear left wheel, T_{w,rf} is the initial torque allocation for the front right wheel, and T_{w,rr} is the initial torque allocation for the rear right wheel. Similarly, F_{z,lf} is the vertical load on the front left wheel, F_{z,lr} is the vertical load on the rear left wheel, F_{z,rf} is the vertical load on the front right wheel, and F_{z,rr} is the vertical load on the rear right wheel. In this way, the total wheel torque on one side of the vehicle 100 is allocated amongst the wheels on that side in proportion to the respective vertical loads.

Next, in step S705 the control unit 130 checks whether the initial torque allocation for each one of the plurality of wheels 101, 102, 103, 104 would exceed the corresponding wheel torque limit for that wheel. If the initial torque allocation for a wheel exceeds the wheel torque limit for that wheel, the wheel may be referred to as ‘saturated’.

If any of the wheels are found to be saturated, then it is determined in step S705 that the initial torque allocations cannot actually be achieved. If this is the case, then in step S706 the control unit 130 revises the initial torque allocations by attempting to re-allocate excess torque that was initially allocated to a saturated wheel to one or more other wheels which are not in saturation, on the same side of the vehicle 100. In a situation where on or more wheels are in saturation, re-allocating torque in step S706 can ensure that the revised torque allocations still provide a total wheel torque on that side of the vehicle 100 that is as close as possible to the required total wheel torque on that side of the vehicle 100, and that the total wheel torque on both sides is as close as possible to the total wheel torque demand. This in turn ensures that a yaw moment is achieved which is as close as possible to the saturated reference yaw moment M_{z,HL,sat}. In step S707, the control unit 130 controls the electric vehicle 100 to apply the revised torque allocations to the plurality of wheels 101, 102, 103, 104.

By comparison, prior art torque allocation methods do not re-allocate excess torque to other wheels. When a wheel is in saturation, this can result in the actual total wheel torque being significantly less than the desired total wheel torque demand. As an example, if there is a vertical load of 4000 N on each wheel and a total wheel torque demand of 2000 Nm on the left-hand side of the vehicle 100, and torque is initially allocated in proportion to the vertical loads in step S704, then the initial torque allocations for the left front wheel 101 and the left rear wheel 103 will both be 1000 Nm. If the individual wheel torque limits for the left front wheel 101 and the left rear wheel 103 are 400 Nm and 2200 Nm respectively, then a conventional torque allocation method without torque re-allocation would result in a wheel torque of 400 Nm being applied at the left front wheel 101 and a wheel torque of 1000 Nm being applied at the left rear wheel 103. This would give a total wheel torque of 1400 Nm on the left-hand side of the vehicle 100, less than the left-hand side total wheel torque demand of 2000 Nm. In contrast, by re-allocating torque in step S706 when the left front wheel 101 is found to be in saturation, the excess torque of 600 Nm can be re-allocated to the left rear wheel 103, ensuring that the total wheel torque demand of 2000 Nm for the left-hand side of the vehicle 100 can still be achieved.

Under certain operating conditions, it may not be possible to satisfy the total wheel torque demand requested by the driver of the vehicle 100 whilst also achieving the saturated reference yaw moment M_{z,HL,sat}. For example, if one or more wheels on one side of the vehicle 100 are in saturation, it may be the case that there is insufficient spare torque capacity at the non-saturated wheels for all of the excess torque from the saturated wheel(s) to be re-allocated. In that event, the total wheel torque on that side of the vehicle will be less than the total wheel torque demand for that side of the vehicle, and the resulting yaw moment will be different to the saturated reference yaw moment M_{z,HL,sat}. In some embodiments of the invention, this can be addressed by modifying the total wheel torque demand T_{w,mod} when a large yaw rate error is detected, that is, when the error between the measured yaw rate and the reference yaw rate exceeds a certain threshold. For example, the total wheel torque demand T_{w,mod} may be decreased from the level requested by the driver before torque allocations are calculated, to ensure that the saturated reference yaw moment M_{z,HL,sat} can still be achieved.

If on the other hand it is found in step S705 that none of the wheels are saturated, then the control unit 130 proceeds directly to step S707 and controls the electric vehicle 100 to apply the initial torque allocations to the plurality of wheels 101, 102, 103, 104. This avoids processing power and system resources being expended unnecessarily revising torque allocations, when the initial torque allocations are acceptable.

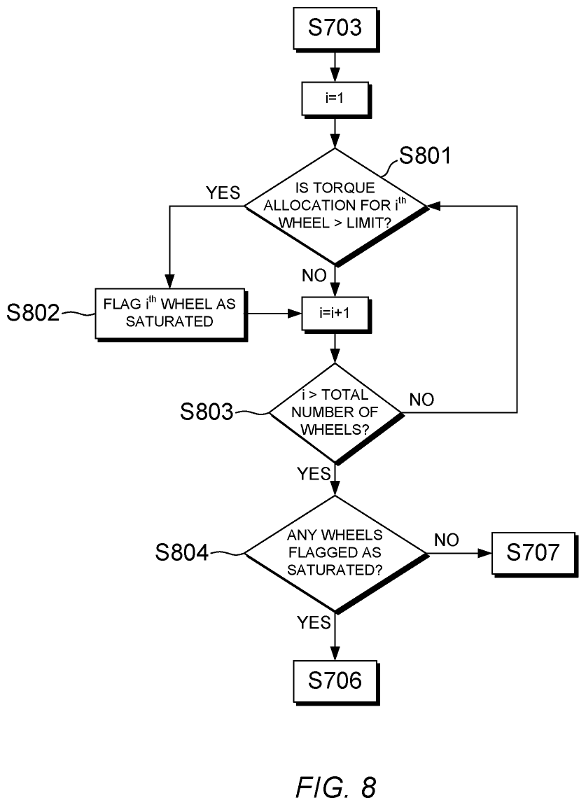

Referring now to FIG. 8, a flowchart showing a method for determining whether to revise the initial torque allocations is illustrated, according to an embodiment of the present invention. The steps illustrated in FIG. 8 may be performed during step S705 of the flowchart shown in FIG. 7. However, in other embodiments a different method may be used in step S705 instead of the one shown in FIG. 8.

First, in step S801 the control unit 130 checks whether each wheel is saturated by comparing the initial torque allocation for each wheel to the individual wheel torque limit for that wheel. If the initial torque allocation for a wheel exceeds the wheel torque limit for that wheel, then the wheel is said to be saturated. For example, if T_{w,lf}>T_{w,lf,max} then the front left wheel is saturated.

If the initial torque allocation for a wheel is found to exceed the torque limit for that wheel in step S801, then in step S802 the wheel is flagged as ‘saturated’, for example by setting a value of a Boolean flag to associated with that wheel to ‘true’. In step S803, the control unit 130 checks whether all wheels have been checked. If not, the control unit repeats steps S801 and S802 until all wheels have been checked.

Then, in step S804 the control unit checks the status of the flags set in step S802 to determine whether any of the wheels were found to be saturated. If none of the wheels were saturated, the process continues directly to step S707, and the electric motors 111, 112, 113, 114 are controlled to apply to respective initial torque allocation to each wheel 101, 102, 103, 104.

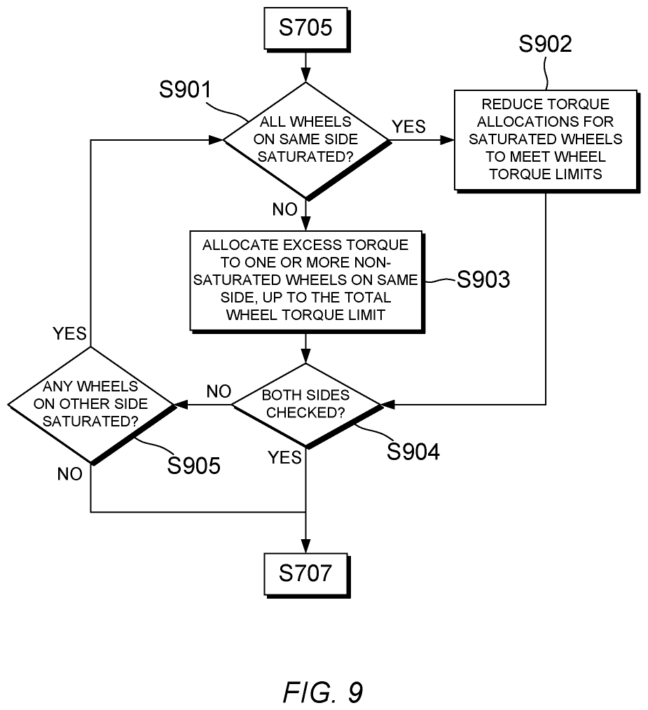

On the other hand, if any wheels were found to be saturated in step S804, then the control unit proceeds to step S706 and calculates revised torque allocations. FIG. 9 is a flowchart showing a method of revising the initial torque allocations if the torque allocation for any of the wheels would exceed the operational limits, according to an embodiment of the present invention. The steps illustrated in FIG. 9 may be performed during step S706 of the flowchart shown in FIG. 7. However, in other embodiments a different method may be used in step S706 instead of the one shown in FIG. 9.

To avoid any confusion, the revised torque allocation for a particular wheel is hereinafter referred to as a level 2 torque allocation, identified by the subscript L2, and the initial torque allocation for a particular wheel is hereinafter referred to as a level 1 torque allocation, identified by the subscript L1.

The process shown in FIG. 9 starts in step S901 by selecting one of the saturated wheels, and checking whether all the wheels on the same side as the selected wheel are also saturated. If all the wheels on one side of the vehicle are saturated, then the control unit 130 proceeds to step S902 and reduces the torque allocations for the wheels on that side to meet the individual wheel torque limits. In the present embodiment the torque allocations are revised in step S902 by setting the L2 torque allocation for each wheel on that side of the vehicle equal to the respective wheel torque limit. In other embodiments the L2 torque allocation could be set lower than the respective wheel torque limit, for example to 90% of the wheel torque limit.

If on the other hand it is found in step S9001 that not all of the wheels on one side are saturated, then in the present embodiment the excess torque that had been allocated to the saturated wheel(s) is re-allocated among any non-saturated wheels on the same side of the vehicle. This ensures that the total wheel torque on that side is as close as possible to, and ideally equal to, the total wheel torque demand on that side. In the present embodiment, torque is re-allocated in step S903.

In step S903 the control unit 130 allocates excess torque from a saturated wheel to a non-saturated wheel on the same side. As in step S902, in step S903 the L2 torque allocation for the saturated wheel is set equal to the individual wheel torque limit for that wheel.

For example, if the front left wheel 101 is saturated and there is spare torque capacity on the rear left wheel 103 (i.e. the rear left wheel 103 is not saturated), then T_{w,lf,L2} is set to be equal to the individual wheel torque limit for the front left wheel 101, T_{w,lf,max}. In this example, this leaves an amount of unallocated torque on the left side of the vehicle equal to T_{w,l,sat}−T_{w,lf,max}. Accordingly, in the present embodiment the L2 torque allocation for the rear left wheel 103 is set to be equal to the difference between the total wheel torque demand for the left side and the wheel torque limit for the front left wheel 101 (T_{w,l,sat}−T_{w,lf,max}), so that that the total torque on the left side of the vehicle is equal to the total wheel torque demand for the left-hand side.

The process of determining the final L2 torque allocations on one side of the vehicle, for example the left-hand side, can be summarised as follows in the case of traction:

$${T}_{w , lf , L 2} = \{ \begin{matrix}{T}_{w , lf , max} , & if {T}_{w , lf , L 1} \geq {T}_{w , lf , max} \\ {T}_{w , lf , L 1} , & if {T}_{w , lf , L 1} < {T}_{w , lf , max} \& {T}_{w , lr , L 1} < {T}_{w , lr , max} \\ {T}_{w , l , sat} - {T}_{w , lr , max} , & if {T}_{w , lf , L 1} < {T}_{w , lf , max} \& {T}_{w , lr , L 1} \geq {T}_{w , lr , max}\end{matrix} \\ {T}_{w , lf , L 2} = \{ \begin{matrix}{T}_{w , l , sat} - {T}_{w , lf , max} , & if {T}_{w , lf , L 1} \geq {T}_{w , lf , max} \& {T}_{w , lr , L 1} < {T}_{w , lr , max} \\ {T}_{w , lr , L 1} , & if {T}_{w , lf , L 1} < {T}_{w , lf , max} \& {T}_{w , lr , L 1} < {T}_{w , lr , max} \\ {T}_{w , lr , max} , & if {T}_{w , lr , L 1} \geq {T}_{w , lf , max}\end{matrix}$$

In the case of braking, the final L2 torque allocations can be summarised as follows:

$${T}_{w , lf , L 2} = \{ \begin{matrix}{T}_{w , lf , min} , & if {T}_{w , lf , L 1} \leq {T}_{w , lf , min} \\ {T}_{w , lf , L 1} , & if {T}_{w , lf , L 1} > {T}_{w , lf , min} \& {T}_{w , lr , L 1} > {T}_{w , lr , min} \\ {T}_{w , l , sat} - {T}_{w , lr , min} , & if {T}_{w , lf , L 1} > {T}_{w , lf , min} \& {T}_{w , lr , L 1} \leq {T}_{w , lr , min}\end{matrix} \\ {T}_{w , lf , L 2} = \{ \begin{matrix}{T}_{w , lr , min} , & if {T}_{w , lr , L 1} \leq {T}_{w , lr , min} \\ {T}_{w , l , sat} - {T}_{w , lf , min} & if {T}_{w , lf , L 1} \leq {T}_{w , lf , min} \& {T}_{w , lr , L 1} > {T}_{w , lr , min} \\ {T}_{w , lr , L 1} , & if {T}_{w , lf , L 1} > {T}_{w , lf , min} \& {T}_{w , lr , L 1} > {T}_{w , lr , min}\end{matrix}$$

where T_{w,lf,L2}=T_{w,lf,L1} and T_{w,lr,L2}=T_{w,lr,L1} indicates that the initial L1 torque allocations for both wheels are retained, in the event that neither wheel on the left-hand side is saturated.

Once the final L2 torque allocations have been determined on one side of the vehicle, in step S904 the control unit 130 checks whether the torque allocations for both sides of the vehicle 100 have been processed. If so, then the process proceeds to step S707, and the control unit 130 controls the electric vehicle 100 to apply the final L2 torque allocations to the wheels 101, 102, 103, 104.

On the other hand, if the other side has not yet been processed, then in step S905 the control unit 130 checks the status of the flags for the wheels on the other side of the vehicle 100 to see whether any of the wheels on the other side were saturated. If any of the wheels on the other side are saturated, then the control unit 130 returns to step S901 and repeats the process to set the L2 torque allocations for the other side of the vehicle. If none of the wheels on the other side were saturated, then the control unit 130 retains the initial L1 torque allocations for that side of the vehicle and continues to step S707 as before.

A method such as the one illustrated in FIG. 9 can be used to re-allocate excess torque from saturated wheels to other wheels with spare torque capacity on the same side of the vehicle, so that the total wheel torque demand can still be achieved.

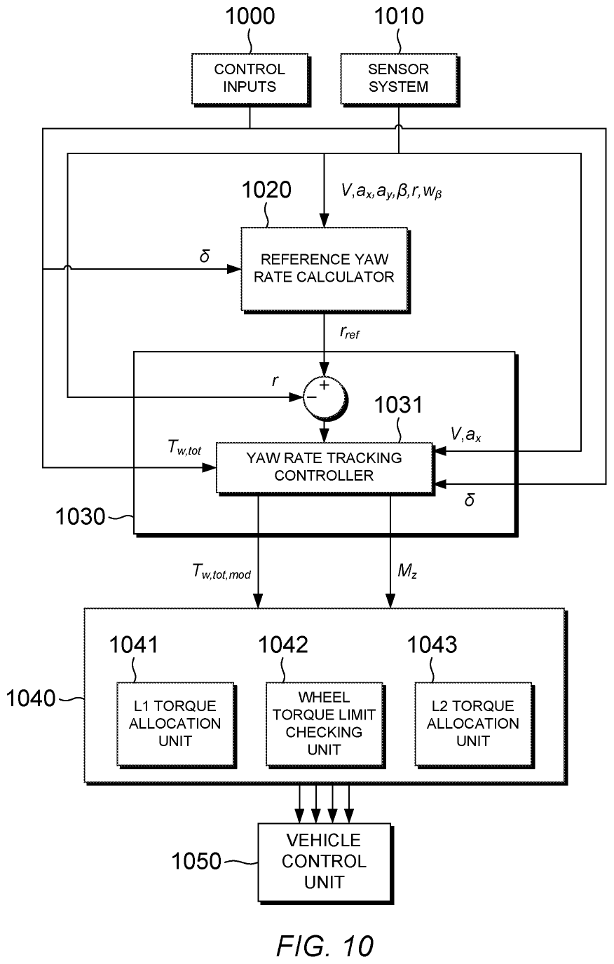

Referring now to FIG. 10, the structure of a control unit for controlling an electric vehicle is schematically illustrated, according to an embodiment of the present invention. The diagram shown in FIG. 10 is intended to convey an understanding of the flow of information within the apparatus, and the operations that are performed. It should be understood that the structure shown in FIG. 10 is provided for illustrative purposes only, and should not be construed as implying a particular physical layout or separation of functions between physical components. For example, certain elements shown in FIG. 10 may be implemented in hardware whilst other elements may be implemented in software.

In the present embodiment the apparatus is configured to receive control inputs 1000 in the form of a total torque demand T_{w,tot} and steering angle δ, and sensor inputs from a sensor system 1010. In the present embodiment the sensor inputs include the rear wheel slip angle βᵣ, the vehicle velocity V, the lateral acceleration a_{y}, the longitudinal acceleration aₓ, and the measured yaw rate r. In other embodiments different sensor inputs may be provided, depending on the method used to calculate the reference yaw moment and the parameters that are needed. The apparatus further comprises a reference yaw rate setting unit 1020 that is configured to set a reference yaw rate r_{ref} based on the steering angle δ and vehicle speed V, and adjusted in accordance with the obtained rear wheel sideslip angle βᵣ.

The apparatus further comprises a reference yaw moment setting unit 1030 configured to set the reference yaw moment M_{z} in accordance with the reference yaw rate r_{ref}, based on the error between the reference yaw rate rᵣₑf and the measured yaw rate r and the total wheel torque demand T_{w,tot}. In the present embodiment the reference yaw moment setting unit 1030 comprises a feedback plus feedforward yaw rate tracking controller 1031 which is configured to receive feedforward inputs including the vehicle velocity V, longitudinal acceleration aₓ, and steering angle δ. In other embodiments the reference yaw moment may be set using only feedback control, rather than feedback and feedforward control as in the present embodiment. The input parameters may be selected in accordance with the chosen control algorithm.

The apparatus further comprises a vehicle control unit 1040 configured to allocate torque to different wheels of the vehicle 100, and a vehicle control unit 1050 to control the electric vehicle 100 to apply the determined torque allocation to the plurality of wheels 101, 102, 103, 104.

Although embodiments of the present invention have been described in relation to electric vehicles, it will be understood that the principles disclosed herein may readily be applied to other types of vehicles which are capable of controlling the level of torque applied to different wheels, for example vehicles with petrol, diesel, LPG (liquid petroleum gas) or hybrid propulsion systems.

Whilst certain embodiments of the invention have been described herein with reference to the drawings, it will be understood that many variations and modifications will be possible without departing from the scope of the invention as defined in the accompanying claims.

1. A method of controlling a vehicle, the method comprising:
determining a saturated reference yaw moment based on an initial reference yaw moment and a total wheel torque demand, taking into account operational limits of the vehicle;
determining initial torque allocations for each one of a plurality of wheels of the electric vehicle based on the saturated reference yaw moment;
for each one of the plurality of wheels, checking whether the initial torque allocation for said wheel exceeds a corresponding wheel torque limit for said wheel; in response to a determination that the initial torque allocation for a first wheel among the plurality of wheels exceeds the corresponding wheel torque limit for the first wheel, and that the initial torque allocation for a second wheel among the plurality of wheels on the same side of the vehicle as the first wheel is less than the corresponding wheel torque limit for the second wheel, revising the initial torque allocations by increasing the torque allocation to the second wheel, and controlling the electric vehicle to apply the revised torque allocations to the plurality of wheels.

2. The method of claim 1, wherein the initial torque allocations are determined based on a vertical load on each of the plurality of wheels.

3. The method of claim 2, wherein the initial torque allocations on one side of the electric vehicle are determined by allocating torque to the plurality of wheels on that side of the electric vehicle in proportion to the respective vertical loads on said wheels.

4. The method of claim 1, wherein determining the saturated reference yaw moment comprises:
determining whether the reference yaw moment exceeds a maximum yaw moment or a minimum yaw moment defined by the operational limits, for the total wheel torque demand; and
in response to a determination that the reference yaw moment exceeds the maximum yaw moment or the minimum yaw moment, capping the saturated reference yaw moment at the maximum yaw moment or the minimum yaw moment respectively.

5. The method of claim 1, wherein the operational limits of the electric vehicle are determined based on a maximum and minimum torque that can be applied to each wheel of the electric vehicle, the operational limits comprising: a maximum yaw moment that can be obtained by applying the maximum torques to a first plurality of wheels on one side of the electric vehicle and applying the minimum torques to a second plurality of wheels on an opposite side of the electric vehicle;
a minimum yaw moment that can be obtained by applying the minimum torques to the first plurality of wheels and applying the maximum torques to the second plurality of wheels;
a maximum total wheel torque that can be obtained by applying the maximum torque to each wheel of the electric vehicle; and
a minimum total wheel torque that can be obtained by applying the minimum torque to each wheel of the electric vehicle.

6. A computer-readable storage medium arranged to store computer program instructions which, when executed, perform the method of claim 1.

7. Apparatus for controlling a vehicle, the apparatus comprising:
a vehicle control unit configured to control the electric vehicle;
a torque allocation unit configured to determine a saturated reference yaw moment based on an initial reference yaw moment and a total wheel torque demand, taking into account operational limits of the vehicle, and determine initial torque allocations for each one of a plurality of wheels of the electric vehicle based on the saturated reference yaw moment;
a wheel torque limit checking unit configured to check, for each one of the plurality of wheels, whether the initial torque allocation for said wheel exceeds a corresponding wheel torque limit for said wheel; and
a torque reallocation unit,
wherein in response to a determination that the initial torque allocation for a first wheel among the plurality of wheels exceeds the corresponding wheel torque limit for the first wheel, and that the initial torque allocation for a second wheel among the plurality of wheels on the same side of the vehicle as the first wheel is less than the corresponding wheel torque limit for the second wheel, the torque reallocation unit is configured to revise the initial torque allocations by increasing the torque allocation to the second wheel, and to control the vehicle control unit to apply the revised torque allocations to the plurality of wheels.

8. The apparatus of claim 7, wherein the torque allocation unit is configured to determine the initial torque allocations based on a vertical load on each of the plurality of wheels.

9. The apparatus of claim 8, wherein the torque allocation unit is configured to determine the initial torque allocations on one side of the electric vehicle by allocating torque to the plurality of wheels on that side of the electric vehicle in proportion to the respective vertical loads on said wheels.

10. The apparatus of claim 7, wherein the torque allocation unit is configured to determine the saturated reference yaw moment by determining whether the reference yaw moment exceeds a maximum yaw moment or a minimum yaw moment defined by the operational limits, for the total wheel torque demand, and in response to a determination that the reference yaw moment exceeds the maximum yaw moment or the minimum yaw moment, capping the saturated reference yaw moment at the maximum yaw moment or the minimum yaw moment respectively.

11. The apparatus of claim 7, wherein the torque allocation unit is configured to determine the operational limits of the electric vehicle based on a maximum and minimum torque that can be applied to each wheel of the electric vehicle, the operational limits comprising:
a maximum yaw moment that can be obtained by applying the maximum torques to a first plurality of wheels on one side of the electric vehicle and applying the minimum torques to a second plurality of wheels on an opposite side of the electric vehicle;
a minimum yaw moment that can be obtained by applying the minimum torques to the first plurality of wheels and applying the maximum torques to the second plurality of wheels;
a maximum total wheel torque that can be obtained by applying the maximum torque to each wheel of the electric vehicle; and
a minimum total wheel torque that can be obtained by applying the minimum torque to each wheel of the electric vehicle.

12. Apparatus for controlling a vehicle, the apparatus comprising:
one or more processors; and
computer-readable memory arranged to store computer program instructions which, when executed by the one or more processors, cause the one or more processors to:
determine a saturated reference yaw moment based on an initial reference yaw moment and a total wheel torque demand, taking into account operational limits of the vehicle;
determine initial torque allocations for each one of a plurality of wheels of the electric vehicle based on the saturated reference yaw moment;
for each one of the plurality of wheels, check whether the initial torque allocation for said wheel exceeds a corresponding wheel torque limit for said wheel; in response to a determination that the initial torque allocation for a first wheel among the plurality of wheels exceeds the corresponding wheel torque limit for the first wheel, and that the initial torque allocation for a second wheel among the plurality of wheels on the same side of the vehicle as the first wheel is less than the corresponding wheel torque limit for the second wheel, revise the initial torque allocations by increasing the torque allocation to the second wheel, and control the electric vehicle to apply the revised torque allocations to the plurality of wheels.

13. The apparatus of claim 12, wherein the computer program instructions are configured to cause the initial torque allocations to be determined based on a vertical load on each of the plurality of wheels.

14. The apparatus of claim 13, wherein the computer program instructions are configured to cause the initial torque allocations on one side of the electric vehicle to be determined by allocating torque to the plurality of wheels on that side of the electric vehicle in proportion to the respective vertical loads on said wheels.

15. The apparatus of claim 12, wherein the computer program instructions are configured to cause the saturated reference yaw moment to be determined by: determining whether the reference yaw moment exceeds a maximum yaw moment or a minimum yaw moment defined by the operational limits, for the total wheel torque demand; and
in response to a determination that the reference yaw moment exceeds the maximum yaw moment or the minimum yaw moment, capping the saturated reference yaw moment at the maximum yaw moment or the minimum yaw moment respectively.

16. The apparatus of claim 12, wherein the computer program instructions are configured to cause the operational limits of the electric vehicle to be determined based on a maximum and minimum torque that can be applied to each wheel of the electric vehicle, the operational limits comprising:
a maximum yaw moment that can be obtained by applying the maximum torques to a first plurality of wheels on one side of the electric vehicle and applying the minimum torques to a second plurality of wheels on an opposite side of the electric vehicle;
a minimum yaw moment that can be obtained by applying the minimum torques to the first plurality of wheels and applying the maximum torques to the second plurality of wheels;
a maximum total wheel torque that can be obtained by applying the maximum torque to each wheel of the electric vehicle; and
a minimum total wheel torque that can be obtained by applying the minimum torque to each wheel of the electric vehicle.

17. A vehicle comprising the apparatus of claim 7.

18. The vehicle of claim 17, wherein the vehicle is an electric vehicle.
